(19) United States
(12) Patent Application Publication
(10) Pub. No.: US 2026/0105013 A1
(43) Pub. Date: Apr. 16, 2026

(54) TRANSIENT STATE MANAGEMENT OF AN INPUT/OUTPUT IMPACTED STORAGE DEVICE

(71) Applicant: Sandisk Technologies, Inc., Milpitas, CA (US)

(72) Inventors: RAMANATHAN MUTHIAH, Bangalore (IN); JUDAH GAMLIEL HAHN, Bangalore (IN)

(73) Assignee: Sandisk Technologies, Inc., Milpitas, CA (US)

(21) Appl. No.: 18/914,582

(22) Filed: Oct. 14, 2024

(51) Int. Cl. G06F 13/18; G06F 12/02; G06F 13/16

(52) U.S. Cl. CPC G06F 13/18; G06F 12/0246; G06F 13/1668

(57) ABSTRACT

A storage device may mitigate impact to a quality-of-service requirement on the storage device during a transient state. The storage device includes a memory to store a logical-to-physical (L2P) table and a volatile memory to cache the L2P table. A controller may set an IO impacted (IOI) bit during initialization of the storage device to cause the storage device to enter the transient state. The controller may provide a first indication to a host to notify the host to transmit host IO requests to be processed without a performance guarantee. During the initialization, the controller may prioritize loading a first category of L2P entries in the volatile memory. After the initialization, the controller may reset the IOI bit and send a second indication to the host to notify the host to transmit the host IO requests to be processed according to the performance guarantee.

### BACKGROUND OF THE INVENTION

A storage device may be communicatively coupled to a host and to non-volatile memory including, for example, a NAND flash memory device on which the storage device may store data received from the host. Storage devices may be categorized, and each category may have a predetermined level of performance. For example, storage devices may be categorized as client storage devices or enterprise storage devices, with enterprise storage devices being designed to provide higher levels of performance and to meet stricter quality-of-service guarantees.

A storage device may store data in blocks on the memory device and the host may address the data using logical block addresses that may be mapped to physical addresses on the memory device. The logical block address to physical address mappings may be stored in a logical-to-physical (L2P) table stored on the memory device and cached on the storage device. To ensure input/output (IO) performance with a constant latency across all logical regions in, for example, an enterprise storage device with stricter quality-of-service guarantees, the entire L2P table may be cached in a dynamic random-access memory (DRAM) on the storage device during initialization of the storage device or any equivalent cold boot from a power/thermal scenario. The loading and caching of the entire L2P table during initialization ensures that the storage device may meet its IO performance guarantees such that any latency in performing IO on the storage device is constant across all logical regions associated with physical regions on the memory device. As such, the latency for accessing data associated with each logical block address may be the same in enterprise applications.

Given that the entire L2P table is cached on a storage device designed to meet stricter quality-of-service guarantees at initialization, the host has to wait for initialization to complete to carry out IO operations on the storage device. There is currently no approach to speed up the initialization of these storage devices such that the host may send IO requests to the storage device and receive IO responses from the storage device before the storage device loads the entire L2P table in its cache.

### SUMMARY OF THE INVENTION

In some implementations, the storage device may manage a transient state during which input/output (IO) operations in a namespace may be impacted and the storage device may mitigate impact to a quality-of-service requirement on the storage device during the transient state. The storage device includes a memory to store a logical-to-physical (L2P) table and a volatile memory to cache the L2P table. A controller may set an IO impacted (IOI) bit during initialization of the storage device to cause the storage device to enter the transient state. The controller may provide a first indication to a host to notify the host to transmit host IO requests to be processed without a performance guarantee. During the initialization, the controller may prioritize loading a first category of L2P entries in the volatile memory. After the initialization, the controller may reset the IOI bit and send a second indication to the host to notify the host to transmit the host IO requests to be processed according to the performance guarantee.

In some implementations, a method is provided on a storage device for mitigating impact to a quality-of-service requirement on the storage device during a transient state. The method includes beginning initialization of the storage device and setting an IOI bit during initialization of the storage device to cause the storage device to enter the transient state. The method also includes providing a first indication to a host to notify the host to transmit host IO requests to be processed without a performance guarantee. The method further includes prioritizing loading a first category of L2P entries in the volatile memory and resetting the IOI bit after initialization of the storage device. The method includes sending a second indication to the host to notify the host to transmit the host IO requests to be processed according to the performance guarantee.

In some implementations, a method is provided on a storage device for mitigating impact to a quality-of-service requirement on the storage device. The method includes determining that a latency condition has occurred on the storage device and setting an IOI bit to cause the storage device to enter a transient state. The method also includes providing a first indication to a host to notify the host to transmit host IO requests to be processed without a performance guarantee. The method further includes correcting a latency condition, resetting the IOI bit, and sending a second indication to the host to notify the host to transmit the host IO requests to be processed according to the performance guarantee.

### BRIEF DESCRIPTION OF THE DRAWINGS

FIG. 1 is a schematic block diagram of an example system in accordance with some implementations.

FIG. 2 is an example block diagram showing initialization of a storage device in accordance with some implementations.

FIG. 3 is an example flow diagram for processing host read requests while initializing a storage device in accordance with some implementations.

FIG. 4 is an example flow diagram for modifying a priority policy and loading a L2P table into a random-access memory according to the priority policy in accordance with some implementations.

FIG. 5 is an example flow diagram for processing host write requests while initializing a storage device in accordance with some implementations.

FIG. 6 is an example flow diagram for tracking a latency inducing condition on a storage device and providing an indication to a host in accordance with some implementations.

FIG. 7 is a block diagram of a networked environment wherein a host may modify data routing and data management in accordance with some implementations.

FIG. 8 is a diagram of an example environment in which systems and/or methods described herein are implemented.

FIG. 9 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

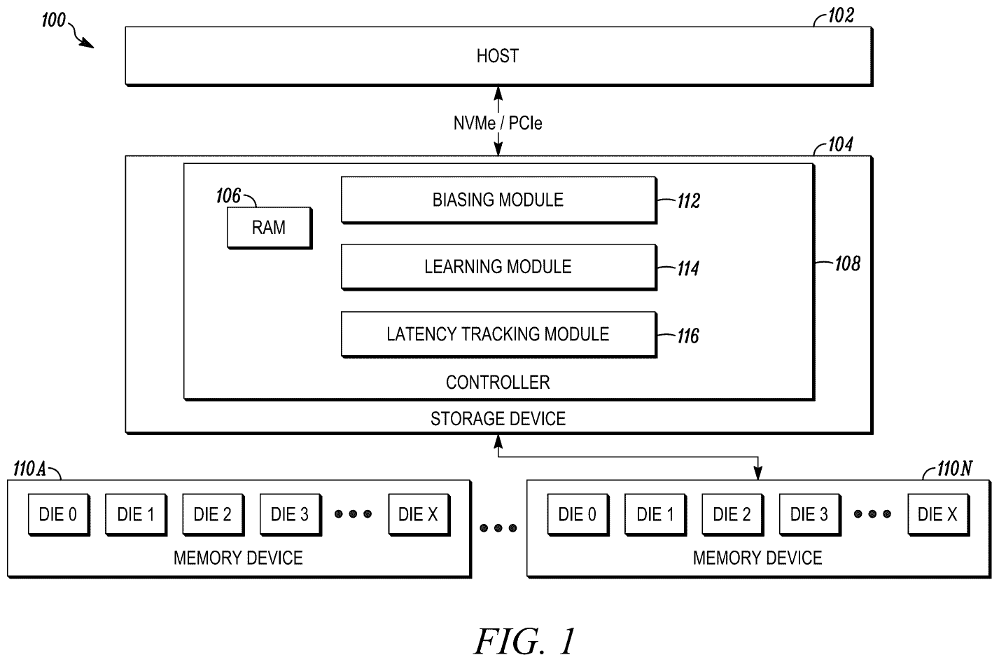

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) interface, and the like. Host 102 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, an enterprise solid-state drive (SSD) with predetermined performance guarantees that may be strictly enforced. RAM 106 may, for example, a static RAM (SRAM) or dynamic RAM (DRAM) that be used to store, for example, a logical-to-physical (L2P) table and other information used on storage device 104.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include multiple dies (for example, DIE 0-DIE X) for storing the data. Memory device 110 may be included in storage device 104 or may be otherwise communicatively coupled to storage device 104.

In rare cases, storage device 104 may be unable to meet its quality-of-service guarantees due to an internal issue on storage device 104. For example, an emergency power failure or unsafe shutdown may result in delayed or slower command processing on storage device 104 that may cause storage device 104 to not meet its quality-of-service guarantees. Controller 108 may set an IO impacted (IOI) bit when storage device cannot meet its quality-of-service guarantees and may provide and an IOI indication to host 102 to inform host 102 to expect latency when host 102 issues an IO request associated with at one or more impacted logical regions. Although host 102 may expect a lower quality-of-service from storage device 104 after receiving the IOI indication from storage device 104, host 102 may still send IO requests to storage device 104.

In some cases, host 102 may use the IOI indication to make other decisions. For example, when host 102 is connected to multiple storage devices 104 and host 102 receives the IOI indication from a first storage device 104a, host 102 may send subsequent IO requests to the other storage devices and may avoid sending IO requests to first storage device 104a. When the internal issues on first storage device 104a are resolved, first storage device 104a may clear/reset its IOI bit and let host 102 know that first storage device 104a is able to meet its predetermined IO performance requirements across all logical regions. Thereafter, host 102 may expect the guaranteed quality-of-service from storage device 104a when storage device 104a processes the host IO requests.

Controller 108 may include a biasing module 112, a learning module 114, and a latency tracking module 116. Biasing module 112 may track pages being processed on storage device 104. Learning module 114 may learn/identify and modify a priority loading policy for loading the L2P table in RAM 106 during a transient state, i.e., a phase during initialization of storage device 104 when caching of the L2P table in RAM 106 may be ongoing in a biased sequence based on the priority loading policy. The priority loading policy may mitigate impacts to the quality-of-service of storage device 104 during the transient state. Latency tracking module 116 may track any latency that may be triggered by one or more conditions.

As storage device 104 is performing IO operations, biasing module 112 may track pages being processed on storage device 104. For example, biasing module 112 may track dirty pages and/or recently used pages on storage device 104. During initialization of storage device 104, controller 108 may set the IOI bit and enter the transient state. During the transient state, controller 108 may load L2P entries in RAM 106 using the priority loading policy. For instance, controller 108 may prioritize loading L2P entries for pages that may likely be read in host read requests received during the transient state. In an example, during the transient state, controller 108 may cache the L2P entries for pages tracked by biasing module 112 during a first period and may cache other L2P entries during one or more subsequent periods after the first period. In this example, the L2P entries cached during the first period may be L2P entries associated with dirty pages and/or recently used pages tracked by biasing module 112 prior to the initialization (in other words, pages that may likely be used for upcoming host read requests during the transient state).

After setting the IOI bit, storage device 104 may send an IOI indication (also referred to herein as a first indication) to host 102 to inform host 102 that storage device 104 is available for IO operations during the transient state without a performance guarantee. Host 102 may send IO requests to storage device 104 during the transient state while L2P entries are still being loaded in RAM 106. As such, host 102 may not have to wait for the loading of the entire L2P table in RAM 106 to begin its IO operations.

Consider an example where storage device 104 is initialized after a power shutdown. Prior to loading the L2P table into RAM 106, controller 108 may set the IOI bit, enter the transient state, and notify host 102 that the IOI bit has been set. Host 102 may send IO requests to storage device 104 during the transient state and storage device 104 may process the host IO requests without a performance guarantee. To minimize latency associated with processing the host read requests received during the transient state, controller 108 may prioritize loading a first category of entries during a first period in the transient state and may load a second category of entries during a second period in the transient state. The priority loading policy used by controller 108 in loading the L2P table into RAM 106 during the transient state may be based on information gathered from biasing module 112 and/or a priority loading policy obtained from learning module 114.

As noted in the example above, the first category of L2P entries stored in RAM 106 may include L2P entries associated with the dirty pages and/or recently used pages tracked by biasing module 112. The second category of L2P entries stored in RAM 106 may include L2P entries associated with pages that were not tracked by biasing module 112. If after loading the first category of L2P entries but before loading the second category of L2P entries, controller 108 processes a host read request for a L2P entry in the first category, the IO performance for the host read request may meet the guaranteed performance of storage device 104. If after loading the first category of L2P entries but before loading the second category of L2P entries, controller 108 processes a host read request for a L2P entry in the second category, the IO performance for the host read request may be impacted and may not meet guaranteed performance of storage device 104. However, host 102 may accept the lower performance during the transient state as a tradeoff for quicker access to storage device 104 for host IO operations.

In some cases, instead of using a recently used policy (i.e., loading L2P entries for recently used pages) to determine a loading sequence/priority during the transient state, controller 108 may fetch dirty L2P entries (i.e., L2P entries associated with regions where writes have occurred and hence have corresponding dirty L2P pages) on a higher priority. Controller 108 may assign the dirty L2P entries to the first category and the non-dirty/clean L2P entries (i.e., L2P entries associated with regions that have not be written to) to the second category. Controller 108 may leverage a concept that host 102 may read data from regions where data was previously written to and hence the L2P entries in those regions would most likely be associated with host read requests during the transient state. Controller 108 may assume that the L2P entries corresponding to untouched regions (clean L2P pages) may not be requested in host read requests during the transient state. As such, controller 108 may load the clean L2P pages during the second period in the transient state. Controller 108 may thus sequence the loading order of L2P entries such that controller 108 may prioritize loading of L2P entries for pages that controller 108 may deem important or L2P entries for pages that controller 108 may speculate may be used for host read requests in the transient state to mitigate impacts to its quality-of-service and meets its performance guarantees for prioritized L2P entries even during the transient period.

During the transient state, if host 102 sends a write request to storage device 104, controller 108 may not need to immediately access the L2P table to process the write request. Controller 108 may create a transient delta segment in RAM 106 and may store the L2P entry for the write request in the transient delta segment. After loading the entire L2P table in RAM 106, controller 108 may reset the IOI bit to indicate to host 102 that subsequent host IO requests may have a fixed latency across all regions. Controller 108 may consolidate the L2P entries in the transient delta segment with the other L2P entries in RAM 106 and may discard the L2P entries in the transient delta segment, thereby absorbing IOI transient latencies related to host write workloads. As such, the transient delta segment may be used to store information associated with write operations performed during the transient state until the entire L2P table is loaded in RAM 106 and controller 108 may manage the control workflow through usage of the transient delta segment.

After initializing storage device 104, controller 108 may reset the IOI bit, and provide a notification (referred to herein as a second notification) to host 102. Host 102 may then expect that subsequent IO operations performed by storage device 104 may meet the guaranteed performance of storage device 104.

Learning module 114 may learn the priority loading policy for loading the L2P table in RAM 106 during the transient state and may modify the priority loading policy. In some cases, learning module 114 may learn the priority loading policy from the initialization IO operations and may modify the priority loading policy during the transient state. In some cases, learning module 114 may modify the priority loading policy by identifying L2P pages that may be requested in host read requests during the transient state to cause those pages to be prioritized when loading the L2P entries in RAM 106. In some cases, learning module 114 may modify the priority loading policy based on the last used range. Learning module 114 may therefore be used to learn/identify those L2P pages that may potentially be used during the transient state, i.e., a period right after a warm boot. By biasing the loading of the L2P table into RAM 106 using information obtained from learning module 114 and not blinding loading L2P entries in RAM 106, storage device 104 may mitigate impacts to its quality-of-service during the transient state. As such, controller 108 may load the L2P entries into RAM 106 during the transient state using an order determined by learning module 114, wherein using the priority loading policy may result in a quicker boot time of storage device 104 and an on-par performance for the most used regions.

Latency tracking module 116 may track any latency that may be triggered by one or more latency conditions such as rare NAND errors. For example, latency tracking module 116 may track rare end-of life failures on storage device 104 including high bit error rate (BER), program failure, and/or erase failure. When controller 108 identifies that a latency condition (for example, an end-of-life failure) has occurred which may cause storage device 104 to take more time than usual in performing IO operations, controller 108 may set the IOI bit based on information from latency tracking module 116. Controller 108 may provide a notification (i.e., the first notification) to host 102 to inform host that the performance of IO operations on storage device 104 may not be guaranteed. Controller 108 may perform an operation to recover from a failure caused by the latency condition, reset the IOI bit, and provide a notification (i.e., the second notification) to host 102. Host 102 may then expect that IO operations performed by storage device 104 may meet the guaranteed performance of storage device 104. Storage device 104 may thus meet the predetermined quality-of-service for normal workloads and transparently provide notice to host 102 on each impact to a logical region (namespace). This may extend the rack life of storage device 104 since host 102 may be able to manage cases where storage device 104 may be unable to meet the guaranteed quality-of-service requirements.

Host 102 may use the IOI indication (first notification) to determine and/or modify data routing and data management to one or more storage devices in a networked environment. For example, if host 102 determines that the IOI bit is set in a first storage device 104a, host 102 may route a workload that it may deem to not require the typical stringent quality-of-service conditions to first storage device 104a. Host 102 may route workloads that it may deem to require stringent quality-of-service conditions to a second storage device 104b that does not have its IOI bit set. Host 102 may also use the transient state in the first storage device 104a to take advantage of sending IO requests to storage device 104a during initialization.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

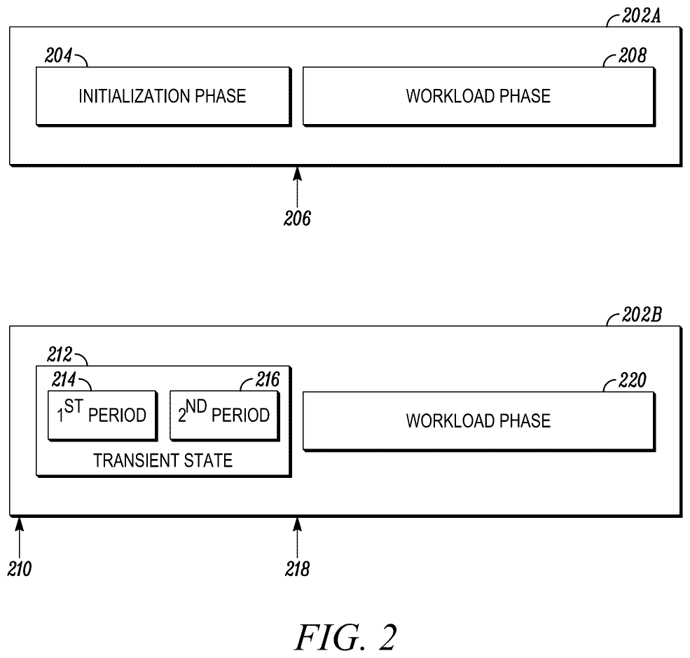

FIG. 2 is an example block diagram showing initialization of a storage device in accordance with some implementations. When storage device 104 does not use the IOI bit during initialization, as shown in 202a, and is powered up, storage device 104 may enter an initialization phase 204. During initialization phase 204, controller 108 may load the entire L2P table into RAM 106. After initialization phase 204, at 206, controller 108 may send an indication to host 102 and storage device 104 may accept IO requests from host 102 in a workload phase 208. Storage device 104 may provide a latency guarantee for the IO requests received in workload phase 208.

When storage device 104 uses the IOI bit during initialization, as shown in 202b, and is powered up, storage device 104 may set the IOI bit at 210, send a notification to host 102 and enter a transient state 212. During transient state 212, controller 108 may load L2P entries in a first category into RAM 106 during a first period 214 and load L2P entries in a second category into RAM 106 during a second period 216. Storage device 104 may accept IO requests from host 102 during transient state 212 and may not provide a latency guarantee for the IO requests received in transient state 212. Storage device 104 may, however, mitigate negative performance impact by loading the L2P entries that are likely to be accessed during transient state 212 during first period 214. After transient state 212, controller 108 may reset the IOI bit at 218, send an indication to host 102, and accept IO requests from host 102 in a workload phase 220. Storage device 104 may provide a latency guarantee for the IO requests received in workload phase 220. As indicated above FIG. 2 is provided as an example. Other examples may differ from what is described in FIG. 2.

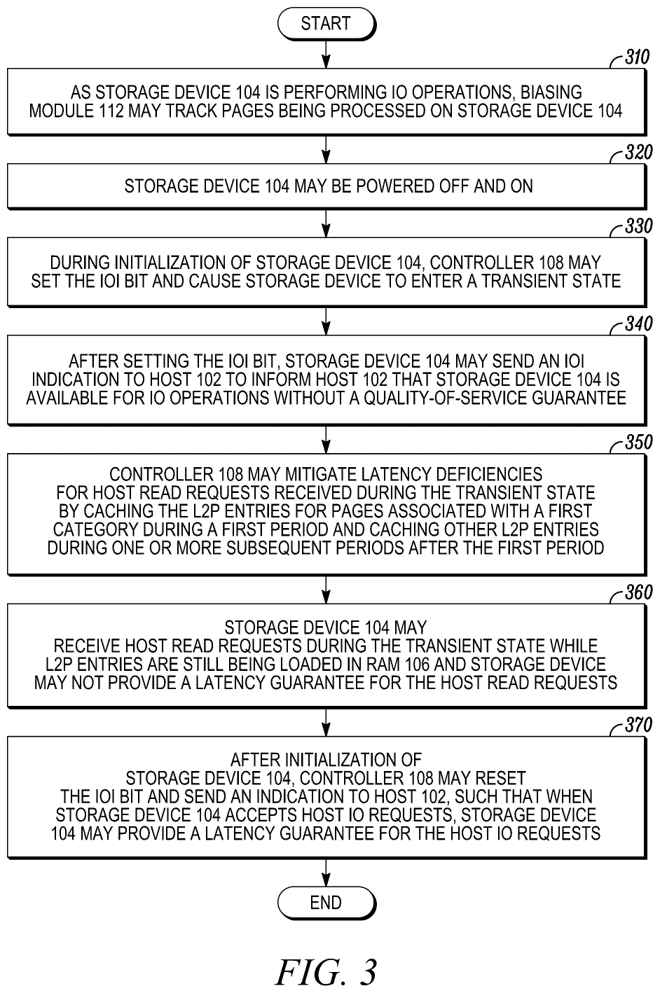

FIG. 3 is an example flow diagram for processing host read requests while initializing a storage device in accordance with some implementations. At 310, as storage device 104 is performing IO operations, biasing module 112 may track pages being processed on storage device 104. At 320, storage device 104 may be powered off and on. At 330, during initialization of storage device 104, controller 108 may set the IOI bit cause storage device 104 to enter a transient state. At 340, after setting the IOI bit, storage device 104 may send an IOI indication to host 102 to inform host 102 that storage device 104 is available for IO operations without a quality-of-service guarantee. At 350, controller 108 may mitigate latency deficiencies for host read requests received during the transient state by caching the L2P entries for pages associated with a first category during a first period and caching other L2P entries during one or more subsequent periods after the first period. At 360, storage device 104 may receive host read requests during the transient state while L2P entries are still being loaded in RAM 106 and storage device may not provide a latency guarantee for the host read requests. At 370, after initialization of storage device 104, controller 108 may reset the IOI bit and send an indication to host 102 such that when storage device 104 accepts host IO requests, storage device may provide a latency guarantee for the host IO requests. As indicated above FIG. 3 is provided as an example. Other examples may differ from what is described in FIG. 3.

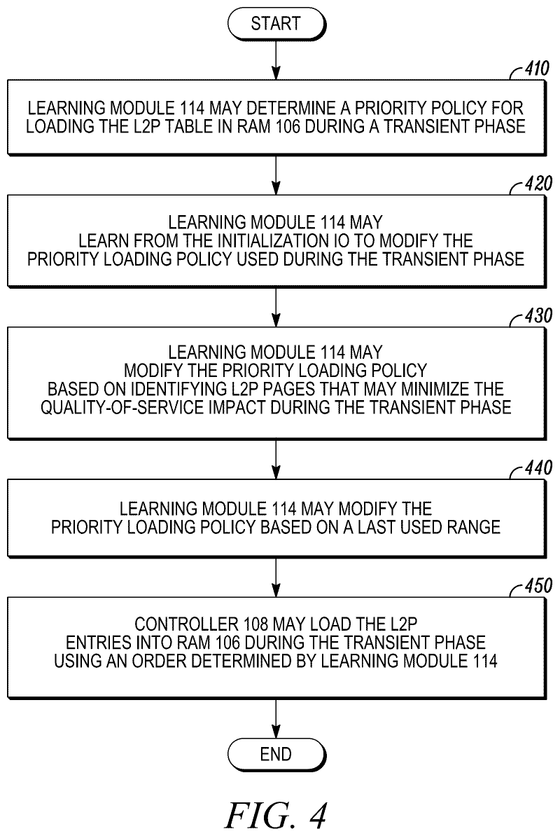

FIG. 4 is an example flow diagram for modifying a priority policy and loading a L2P table into a random-access memory according to the priority policy in accordance with some implementations. At 410, learning module 114 may determine a priority policy for loading the L2P table in RAM 106 during a transient state. At 420, learning module 114 may learn from the initialization IO to modify the priority loading policy used during the transient state. At 430, learning module 114 may modify the priority loading policy based on identifying L2P pages that may minimize the quality-of-service impact during the transient state since the identified L2P pages may be the ones that may be anticipated to be used during the transient state. At 440, learning module 114 may modify the priority loading policy based on a last used range. At 450, controller 108 may load the L2P entries into RAM 106 during the transient state using an order determined by learning module 114. At 460, controller 108 may detect pages being loaded into RAM 106 that are in sync with learned priority loading policy. As indicated above FIG. 4 is provided as an example. Other examples may differ from what is described in FIG. 4.

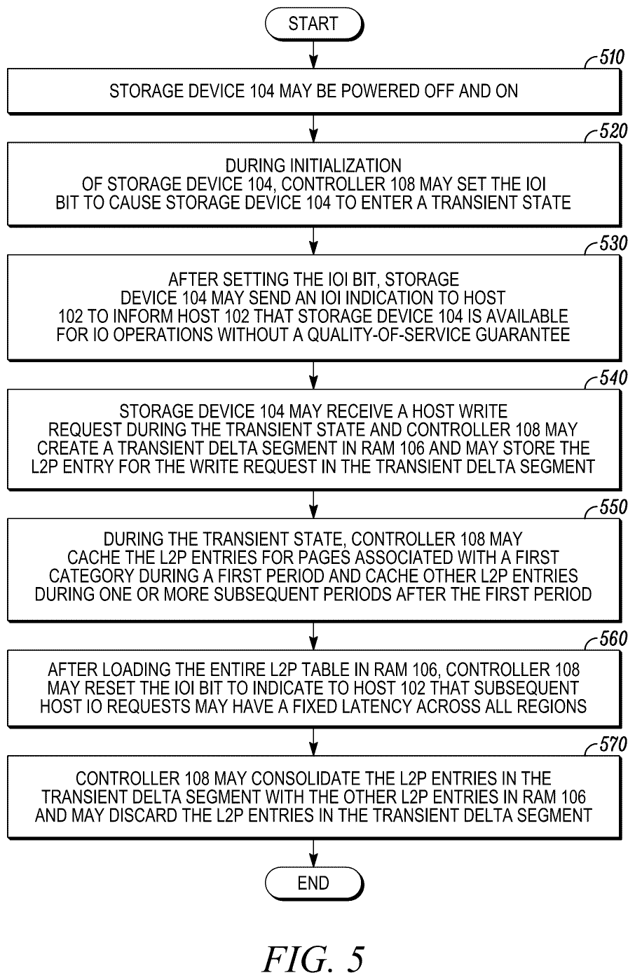

FIG. 5 is an example flow diagram for processing host write requests while initializing a storage device in accordance with some implementations. At 510, storage device 104 may be powered off and on. At 520, during initialization of storage device 104, controller 108 may set the IOI bit and enter a transient state. At 530, after setting the IOI bit, storage device 104 may send an IOI indication to host 102 to inform host 102 that storage device 104 is available for IO operations without a quality-of-service guarantee. At 540, storage device 104 may receive a host write request during the transient state and controller 108 may create a transient delta segment in RAM 106 and may store the L2P entry for the write request in the transient delta segment. At 550, during the transient state, controller 108 may cache the L2P entries for pages associated with a first category during a first period and cache other L2P entries during one or more subsequent periods after the first period. At 560, after loading the entire L2P table in RAM 106, controller 108 may reset the IOI bit to indicate to host 102 that subsequent host IO requests may have a fixed latency across all regions. At 570, controller 108 may consolidate the L2P entries in the transient delta segment with the other L2P entries in RAM 106 and may discard the L2P entries in the transient delta segment. As indicated above FIG. 5 is provided as an example. Other examples may differ from what is described in FIG. 5.

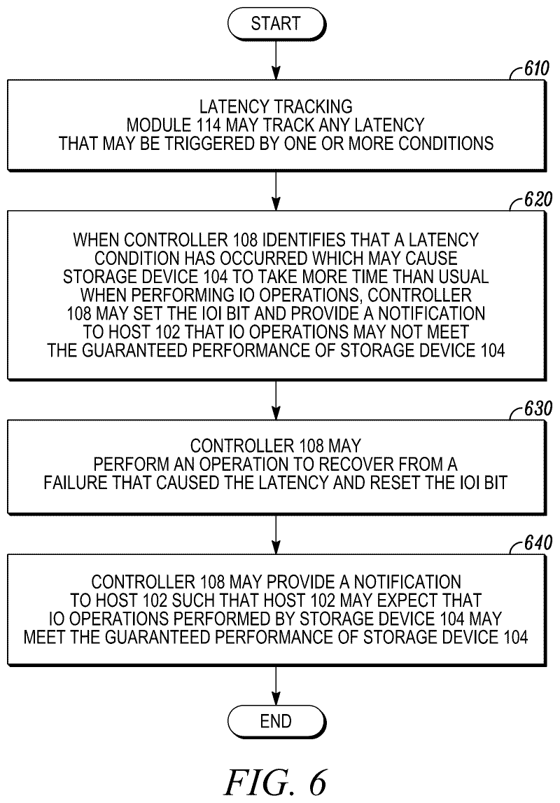

FIG. 6 is an example flow diagram for tracking a latency inducing condition on a storage device and providing an indication to a host in accordance with some implementations. At 610, latency tracking module 116 may track any latency that may be triggered by one or more conditions. At 620, when controller 108 identifies that a latency condition has occurred which may cause storage device 104 to take more time than usual when performing IO operations, controller 108 may set the IOI bit and provide a notification to host 102 that IO operations may not meet the guaranteed performance of storage device 104. At 630 controller 108 may perform an operation to recover from a failure that caused the latency and reset the IOI bit. At 640, controller 108 may provide a notification to host 102 such that host 102 may expect that IO operations performed by storage device 104 may meet the guaranteed performance of storage device 104. As indicated above FIG. 6 is provided as an example. Other examples may differ from what is described in FIG. 6.

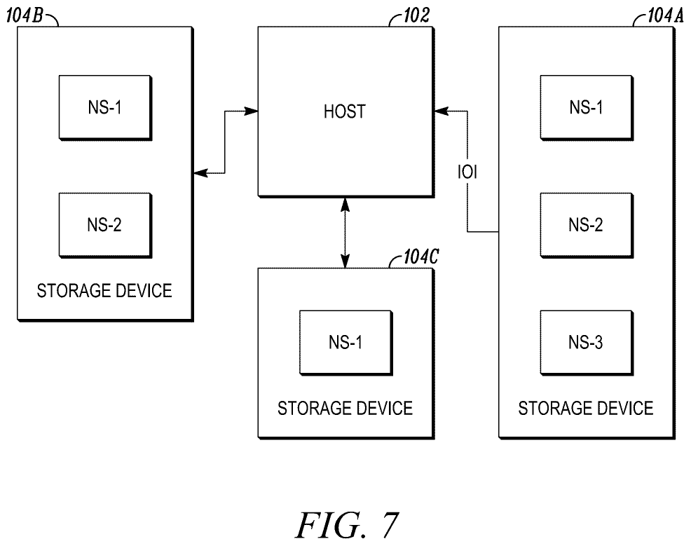

FIG. 7 is a block diagram of a networked environment wherein a host may modify data routing and data management in accordance with some implementations. Host 102 may send IO requests to storage devices 104a, 104b, and 104c, each of which may include one or more namespaces (NS-1-NS-3), i.e., logical regions associated with physical regions on memory device 110. Storage device 104a may send an IOI indication to host 102 during initialization of storage device 104a or when a latency condition occurs at a namespace in storage device 104a. Host 102 may route IO requests that may not require the quality-of-service guarantee to storage device 104a. Host 102 may also route IO requests that may require the quality-of-service conditions to storage device 104b and/or 104c that do not have the IOI bit set. When storage device 104a clears the condition that impacts its quality-of-service, storage device 104a may reset the IOI bit and send an indication to host 102. Host 102 may then route IO requests that may require the quality-of-service guarantees to storage device 104a. As indicated above FIG. 7 is provided as an example. Other examples may differ from what is described in FIG. 7.

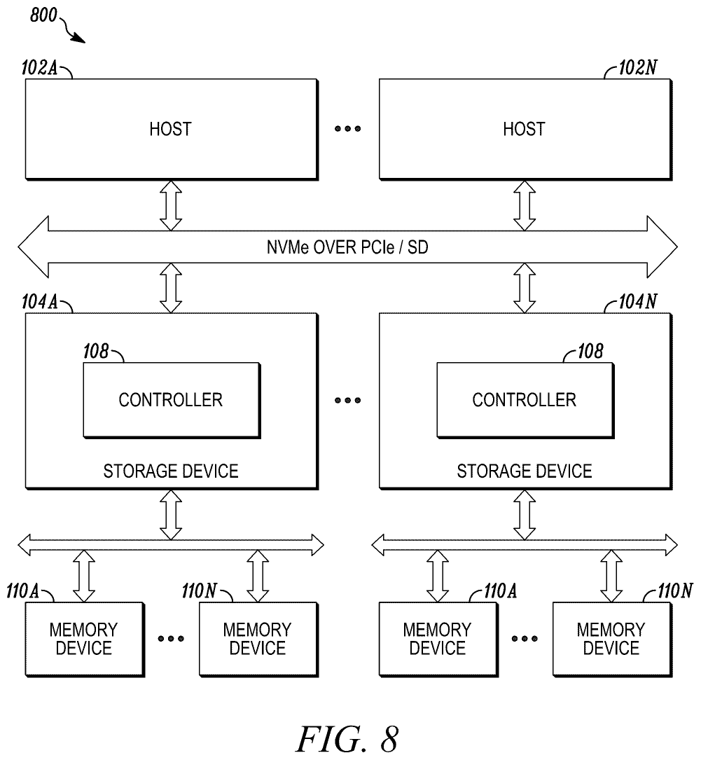

FIG. 8 is a diagram of an example environment in which systems and/or methods described herein are implemented. As shown in FIG. 8, Environment 800 may include hosts 102-102n (referred to herein as host(s) 102), and one or more storage devices 104a-104n (referred to herein as storage device(s) 104). Storage device 104 may include a controller 108 to mitigate impacts to a quality-of-service requirement on the storage device during the transient state. Hosts 102 and storage devices 104 may communicate via Non-Volatile Memory Express (NVMe) over peripheral component interconnect express (PCI Express or PCIe), SD, or the like.

Devices of Environment 800 may interconnect via wired connections, wireless connections, or a combination of wired and wireless connections. For example, the network in FIG. 8 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of Environment 800 may perform one or more functions described as being performed by another set of devices of Environment 800.

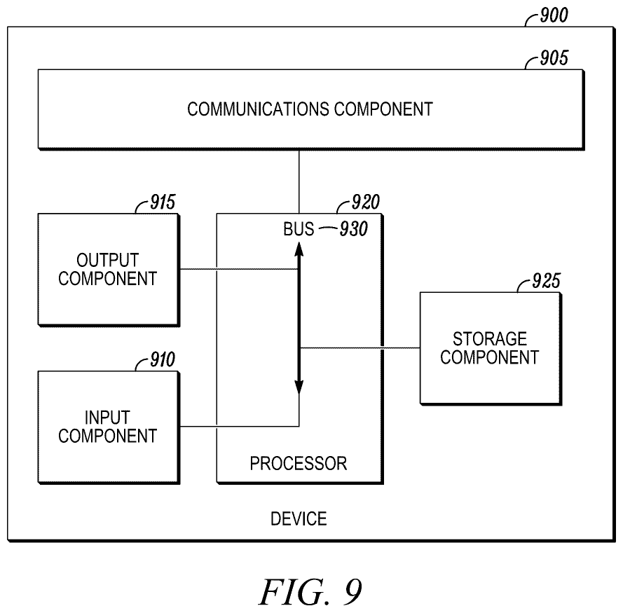

FIG. 9 is a diagram of example components of one or more devices of FIG. 1. In some implementations, host 102 may include one or more devices 900 and/or one or more components of device 900. Device 900 may include, for example, a communications component 905, an input component 910, an output component 915, a processor 920, a storage component 925, and a bus 930. Bus 930 may include components that enable communication among multiple components of device 900, wherein components of device 900 may be coupled to be in communication with other components of device 900 via bus 930.

Input component 910 may include components that permit device 900 to receive information via user input (e.g., keypad, a keyboard, a mouse, a pointing device, and a network/data connection port, or the like), and/or components that permit device 900 to determine the location or other sensor information (e.g., an accelerometer, a gyroscope, an actuator, another type of positional or environmental sensor). Output component 915 may include components that provide output information from device 900 (e.g., a speaker, display screen, and network/data connection port, or the like). Input component 910 and output component 915 may also be coupled to be in communication with processor 920.

Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 may include one or more processors capable of being programmed to perform a function. Processor 920 may be implemented in hardware, firmware, and/or a combination of hardware and software.

Storage component 925 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 920. A memory device may include memory space within a single physical storage device or memory space spread across multiple physical storage devices. Storage component 925 may also store information and/or software related to the operation and use of device 900. For example, storage component 925 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 905 may include a transceiver-like component that enables device 900 to communicate with other devices, such as via a wired connection, a wireless connection, or a combination of wired and wireless connections. The communications component 905 may permit device 900 to receive information from another device and/or provide information to another device. For example, communications component 905 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range.

Communications component 905 may also include one or more broadband and/or narrowband transceivers and/or other similar types of wireless transceiver configurable to communicate via a wireless network for infrastructure communications. Communications component 905 may also include one or more local area network or personal area network transceivers, such as a Wi-Fi transceiver or a Bluetooth transceiver.

Device 900 may perform one or more processes described herein. For example, device 900 may perform these processes based on processor 920 executing software instructions stored by a non-transitory computer-readable medium, such as storage component 925. As used herein, the term “computer-readable medium” refers to a non-transitory memory device. Software instructions may be read into storage component 925 from another computer-readable medium or from another device via communications component 905. When executed, software instructions stored in storage component 925 may cause processor 920 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to manage a transient state during which input/output (IO) operations in a namespace is impacted and to mitigate impacts to a quality-of-service requirement on the storage device during the transient state, the storage device comprises:
a memory to store a logical-to-physical (L2P) table;
a volatile memory to cache the L2P table; and
a controller to set an IO impacted (IOI) bit during initialization of the storage device to cause the storage device to enter a transient state, provide a first indication to a host to notify the host to transmit host IO requests to be processed without a performance guarantee, prioritize loading a first category of L2P entries in the volatile memory, reset the IOI bit after initialization of the storage device, and send a second indication to the host to notify the host to transmit the host IO requests to be processed according to the performance guarantee.

2. The storage device of claim 1, further comprising a learning module to identify a priority loading policy to load a L2P table in the volatile memory during the transient state.

3. The storage device of claim 2, wherein the learning module learns the priority policy from an initialization IO operation and modifies the priority based on a last used range.

4. The storage device of claim 1, wherein the controller loads a second category of L2P entries after loading the first category of L2P entries.

5. The storage device of claim 1, wherein the first category of L2P entries includes L2P entries for pages that are likely to be in host read requests received during the transient state.

6. The storage device of claim 1, wherein the first category of L2P entries includes at least one of dirty L2P entries and L2P entries associated with at least one of dirty pages and recently used pages.

7. The storage device of claim 1, further comprising a biasing module to track pages being processed on the storage device prior to initialization of the storage device.

8. The storage device of claim 7, wherein the biasing module tracks at least one of dirty pages and recently used pages on the storage device.

9. The storage device of claim 7, wherein the controller caches the L2P entries for pages tracked by a biasing module during a first period and caches other L2P entries during one or more subsequent periods after the first period.

10. The storage device of claim 1, wherein the controller receives a host write request in the transient state, creates a transient delta segment in the volatile memory, and stores a L2P entry for the host write request in the transient delta segment.

11. The storage device of claim 10, wherein after loading an entire L2P table in the volatile memory, the controller consolidates L2P entries in the transient delta segment with the other L2P entries in the volatile memory and discards the L2P entries in the transient delta segment.

12. The storage device of claim 1, further comprising a latency tracking module to track latency triggered by a latency condition.

13. The storage device of claim 12, wherein when the controller identifies that a latency condition has occurred, the controller sets the IOI bit, sends the first indication to the host, corrects the latency condition, and sends a second notification to the host.

14. The storage device of claim 1, further wherein when the controller receives a host IO request in the transient state, the storage device processes the host IO request with the performance guarantee.

15. A method in a storage device for mitigating impacts to a quality-of-service requirement on the storage device during a transient state during which input/output (IO) operations in a namespace is impacted, the storage device comprises a controller to execute the method comprising:
beginning initialization of the storage device;
setting an IO impacted (IOI) bit during initialization of the storage device to cause the storage device to enter a transient state;
providing a first indication to a host to notify the host to transmit host IO requests to be processed without a performance guarantee;
prioritizing loading a first category of L2P entries in a volatile memory;
resetting the IOI bit after initialization of the storage device; and
sending a second indication to the host to notify the host to transmit the host IO requests to be processed according to the performance guarantee.

16. The method of claim 15, further comprising loading a second category of L2P entries after loading the first category of L2P entries.

17. The method of claim 15, further comprising assigning at least one of dirty L2P entries and L2P entries at least one of associated with dirty pages and recently used pages to the first category.

18. The method of claim 15, further comprising receiving a host write request in the transient state, creating a transient delta segment in the volatile memory, storing a L2P entry for the host write request in the transient delta segment, loading an entire L2P table in the volatile memory, consolidating L2P entries in the transient delta segment with the other L2P entries in the volatile memory, and discarding the L2P entries in the transient delta segment.

19. The method of claim 16, further comprising tracking latency triggered by a latency condition, and when the latency condition has occurred, setting the IOI bit, sending the first indication to the host, correcting the latency condition, and sending a second notification to the host.

20. A method in a storage device for mitigating impacts to a quality-of-service requirement on the storage device, the storage device comprises a controller to execute the method comprising:
determining that a latency condition has occurred on the storage device;
setting an IO impacted (IOI) bit to cause the storage device to enter a transient state;
providing a first indication to a host to notify the host to transmit host IO requests to be processed without a performance guarantee;
correcting a latency condition;
resetting the IOI bit; and
sending a second indication to the host to notify the host to transmit the host IO requests to be processed according to the performance guarantee.
